(19) United States
(12) Patent Application Publication
(10) Pub. No.: US 2004/0081117 A1
(43) Pub. Date: Apr. 29, 2004

(54) Method for a synchronized hand off from a cellular network to a wireless network and apparatus thereof

(76) Inventors: Charles John Malek, Barrington, IL (US); Shaowei Pan, Kildeer, IL (US)

Correspondence Address: VEDDER PRICE KAUFMAN & KAMMHOLZ, 222 N. LASALLE STREET, CHICAGO, IL, 60601, US

(21) Appl. No.: 10/282,654

(22) Filed: Oct. 29, 2002

(51) Int. Cl. H04B 7/216

(52) U.S. Cl. 370/324; 370/342; 370/338

(57) ABSTRACT

A method and apparatus for synchronized hand off from a cellular network (138) to a wireless network (100) includes an antenna (110) capable of receiving a synchronization channel and a pilot channel (112). Within the wireless network (100) is an access point (104) and a cellular timing recovery receiver (106) coupled to the antenna (110). The cellular timing recovery receiver (106) receives the synchronization channel and the pilot channel (112), which are provided to the access point (104) from a cellular base station (114). The cellular timing recovery receiver (106) thereupon generates a clock pulse (120) and a clock setting signal (122) which are provided to the access point (104), which are utilized to synchronize an internal clock with respect to the timing of the cellular base station (114). Thereupon, the wireless area network (100) may be synchronized with a cellular network (138) message information (150c).

### BACKGROUND OF THE INVENTION

The invention relates generally to a wireless communication network, and more specifically to handing off a communication between a cellular network and a wireless area network, wherein a network includes an individual or combination of communication paths for providing communication therethrough.

With the development of wireless local area networks (WLANs) operating under defined wireless technology, such as a Bluetooth, an IEEE 802.11b standard, an IEEE 802.11a standard, or any other suitable communication interface for allowing wireless communication across the wireless local area network, there are many advantages to being able to utilize a wireless local area network rather than a standard cellular network, such as, but not limited to, a code division multiple access (CDMA) cellular network, for communication. Among other things, a typical wireless local area network has higher bandwidth capacity for transferring data and may also provide cheaper communication by excluding usage tolls commonly found within cellular networks. One major limitation of the wireless local area network is the available range for continued communication as wireless local area networks typically require the user to be within a shorter radius of coverage of an access point for communicating between the communication device and a subsequent network or another communication device, wherein the communication device includes, but not limited to, a terminal computer, a mobile computing device, a personal digital assistant, a mobile telephone, or any other suitable device capable of engaging in wireless communication.

To improve efficiency, it is advantageous for a user, when communicating through a cellular network, to be able to switch the communication to be through a WLAN when the user is within range of the WLAN. For the communication device to be handed off between the cellular network and the WLAN, there must be some mechanism for synchronizing voice signals between the cellular network and the WLAN. One compensation approach is to provide buffers of sufficient length to accommodate the time-base disparity between a transmitter and a receiver operating across a plesio-synchronous boundary However, such known buffering methods alone are inadequate because frame erasures, or end-to-end delays due to excessive buffer length, may still occur resulting in poor voice quality.

A typical cellular base transceiver station (BTS), a single sector CDMA Motorola SC300 series BTS, for example, is synchronized to a Global Positioning System (GPS) timing reference. The cellular BTS transmits a pilot channel and a synchronization channel that enable synchronization for de-spreading and decoding by mobile stations. A cellular mobile station obtains the system time by decoding a synchronization message from the synchronization channel. To decode the synchronization channel, the mobile station must first obtain the pilot channel because the frame boundary of the synchronization channel is aligned with the start of the wireless network sequence contained in the pilot channel. After decoding the synchronization channel, the wireless mobile station adjusts its internal timers, long pseudo random code generator starting point, real-time clock (RTC), and oscillator driving its clock distribution tree.

Synchronization of the cellular base station with the GPS timing requires special receiving equipment including an antenna. The antenna must be positioned, typically on a rooftop, such that it will have a relatively unobstructed hemispheric view and can adequately receive the GPS satellite constellation's signals. This type of system and installation is relatively inconvenient for many residences and small office complexes.

Because WLAN access points are not aligned with the same timing reference as a cellular network, seamless handovers or hand offs would require the installation of a GPS equipment at the access point in order to minimize the required buffer length and thereby improve voice quality. Although installation of GPS equipment at a WLAN access point location would be the ideal solution, this is an inconvenient and costly option for most WLAN access point installations.

### BRIEF DESCRIPTION OF THE DRAWINGS

The invention will be more readily understood with reference to the following drawings wherein:

FIG. 1 illustrates an example of an apparatus for the synchronized handover between a wireless area network and a cellular network;

FIG. 2 illustrates an example of the apparatus of FIG. 1, including further illustration of the cellular network, in accordance with one embodiment of the present invention;

FIG. 3 illustrates, in block diagram form, an example of a cellular timing recovery receiver, in accordance with one embodiment of the present invention;

FIG. 4 illustrates an example of a frame of information transmitted by the communication device, in accordance with one embodiment of the present invention;

FIG. 5 illustrates an example of a hand off device for use in accordance with one embodiment of the present invention;

FIG. 6 illustrates an example of the steps of a method for a synchronized hand off from a cellular network to a wireless network, in accordance with one embodiment of the present invention;

FIG. 7 illustrates an example of a method for synchronized hand off from the cellular network to a wireless network, in accordance with one embodiment of the present invention; and

FIG. 8 illustrates an example of a method for a synchronized hand off from a first communication network to a second communication network, in accordance with one embodiment of the present invention.

### DETAILED DESCRIPTION OF A PREFERRED EMBODIMENT OF THE INVENTION

Briefly, a method and apparatus for synchronized handoff from a cellular network to a wireless network includes an antenna capable of receiving a synchronization channel and a pilot channel. Within a WLAN access point, a cellular timing recovery receiver is coupled to the antenna. The cellular timing recovery receiver receives the synchronization channel and the pilot channel from the antenna. The synchronization channel and the pilot channel are provided to the cellular timing recovery receiver within the WLAN access point from a cellular base station. The WLAN access point having the antenna and cellular timing recovery receiver utilizes the synchronization channel and the pilot channel to generate a clock pulse, wherein the clock pulse may be used for the synchronization of the WLAN with the cellular network. As such, a message signal from a first communication device may be provided both to the WLAN and the cellular network simultaneously, thereby enabling the first communication device to achieve a synchronous soft handover from either the WLAN to the cellular network, or from the cellular network to the WLAN.

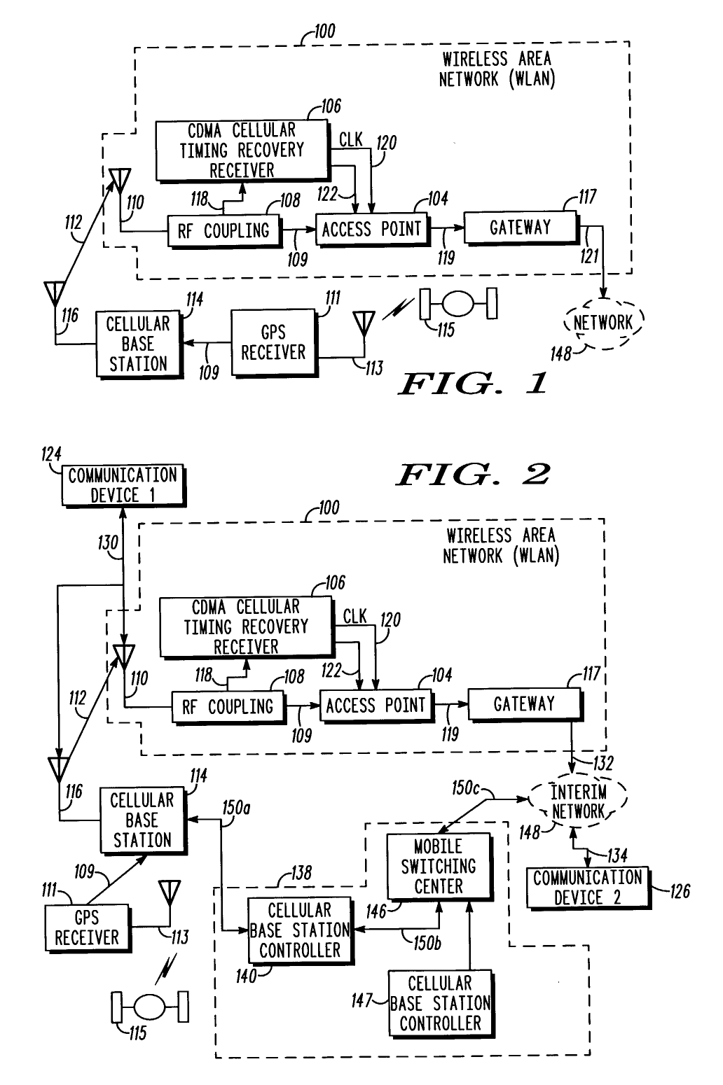

FIG. 1 illustrates a WLAN 100, having an access point 104, CDMA cellular timing recovery receiver 106, a radio frequency coupling device 108, and an antenna 110 and a gateway 117. The antenna 110 receives a forward link synchronization channel and a pilot channel 112 from a cellular base station 114, more specifically from an antenna 116 of the cellular base station 114. The synchronization channel and pilot channel 112 are standard signals generated and transmitted by the cellular base station 114 to facilitate normal cellular communication, including timing information for cellular communication. Also illustrated in FIG. 1, the cellular base station 114 receives timing information 109 from a GPS receiver 111, which is received from an antenna 113 from a satellite 115. Moreover, the radio frequency coupling device 108 may provide a signal 109, such as a message signal as discussed below with reference to FIG. 2, to the access point 104. The access point 104 provides an access point signal 119 to the gateway 117 and thereupon a communication signal to an interim network 148.

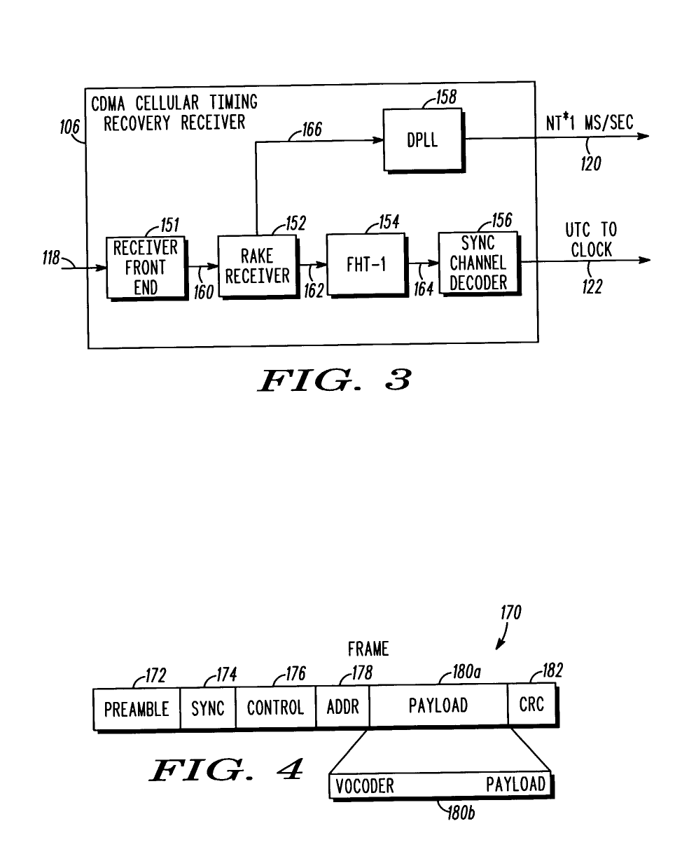

The radio frequency coupling device 108 receives the cellular base station 114 forward link signal 112 comprising a synchronization channel and pilot channel 112 and provides a forward link signal 118 to the CDMA cellular timing recovery receiver 106. Thereupon, as discussed below with reference to FIG. 3, the CDMA cellular timing recovery receiver 106 generates a clock pulse 120 and a clock setting signal 122, which is provided to the access point 104. The access point 104 thereupon utilizes the clock signal 120 and the clock setting signal 122 to generate internal timing information which is synchronized with the CDMA cellular base station 114 because the internal timing information is based upon the same timing reference, more specifically the GPS timing reference, which is being utilized by cellular base station 114.

It is also noted that in another embodiment, the synchronization channel and pilot channel 112 may be provided to the first antenna 110 which may be coupled directly to the CDMA cellular timing recovery receiver 106 instead of utilizing the radio frequency coupling device 108. Further, in accordance with this embodiment the access point 104 may have a second antenna (not shown) directly coupled to it such that the embodiment comprises two antennas; one antenna coupled to the CDMA cellular timing recovery receiver 106, and one antenna coupled to access point 104. It is also noted that in one embodiment, the synchronization channel and pilot channel 112 is transmitted as a radio frequency signal.

FIG. 2 illustrates the WLAN 100 of FIG. 1 with respect to a standard communication system having a first communication device 124 and a second communication device 126. The first communication device 124 and the second communication device 126 may be a terminal computer, a mobile computing device, such as a laptop computer, a person digital assistant, a mobile or cellular telephone, or any other suitable device capable of engaging in communication. The system of FIG. 2 further includes the wireless access point 100 having the CDMA cellular timing recovery receiver 106, the radio frequency coupling device 108 and the access point 104.

The system 123 further includes the cellular base station 114 having the antenna 116 disposed thereon. Also included is an interim network 148 disposed between the wireless access point 102 and the second communication device 126. The interim network 148 may be any type of network whereupon information from the first communication device 124 may be provided to the second communication device 126 using the cellular base station 114 or the WLAN 100, such as, but not limited to, a public switched telephone network (PSTN). The cellular network 138 includes a cellular base station controller (CBSC) 140 and a mobile switching center 146. As recognized by one having ordinary skill in the art, many other elements within a standard cellular network have been omitted for clarity purposes only and the cellular network 138 is for illustrative purposes only and not designated as being so limiting herein.

The first communication device 124 generates a message signal 130, which is provided to the antenna 110 of the WLAN 100 and the antenna 116 of the cellular base station 114. The message signal 130 includes any type of message information provided from the first communication device 124 intended for the second communication device 126, such as a packet of voice data, text data, or any other suitable information. As recognized by one having ordinary skill in the art, the first communication device 124 will generate the message information 130 provided to the cellular base station 114, via the antenna 116, until the first communication device 124 is within the access range of the wireless access point 102. The access point 104 is associated with the wireless area network WLAN 100 having a limited range for receiving the message information 130, and as such, the first communication device 124 may be solely providing the message information 130 to the second communication device 126 through the cellular base station 114 until the first communication device 124 gets within the reception range of the antenna 110.

In one embodiment, the communication device 124 includes a radio signal strength indicator, which receives an incoming signal from the wireless area network 100, more specifically from the antenna 110 of the wireless area network 100. When the radio signal strength indicator is equal to or above a threshold value, the communication device 124 may successfully transmit message information 130 to the wireless area network 100. Furthermore, when the communication device 124 provides the message information 130 to the wireless area network, the communication device 124 can cancel transmission to the cellular network, as long as the radio signal strength indicator remains equal to or above a threshold value to insure proper communication. Alternatively the mobile station decision may be based upon other criteria independently, or in addition to, or in combination with a radio signal strength indication and other measurements known by those skilled in the art such as, but not limited to, Frame Erasure Rate (FER), Bit Error Rate (BER). Additionally, a scenario may exist where communication device 124 is in communication between the WLAN 100 and the cellular network 138, and wherein the WLAN 100 is under an ownership, coordination, or other agreement, with the owner or operator of mobile switching center 146. In this scenario, the decision of when communication device 124 completes a handover operation by terminating a communication with either the WLAN 100 or the cellular network 138 would be determined by the mobile switching center 146. In a second scenario, the decision of when communication device 124 completes a handover operation may be determined by a control element residing within interim network 148, such as for example a WLAN radio access network control function.

Within the WLAN 100, the clock pulse 120 and the clock setting signal 122 are provided to the access point 104. Utilizing both of the clock pulse 120 and the clock setting signal 122, the access point 104 is synchronized with the cellular base station 114. The access point 104 receives the communication information 109 as provided from the radio frequency coupling device 108, wherein the access point 104 thereupon generates a wireless network message 132 which is provided to the interim network 148. The interim network 148 provides a message information 134 to the second communication device 126, wherein the message information 134 includes the cellular message information 132 and any formatting, header or routing information generated by the interim network 148.

During communication across the cellular network, the message information 130 is provided to the cellular network 138 through the cellular base station 114. The cellular base station 114 provides a cellular base station conversion message signal 150a to the cellular base station controller 140, wherein the cellular conversion message signal 150a is the message signal 130 including any modifications created by the cellular base station 114, in accordance with known cellular base station technology. The cellular base station controller 140 is coupled to a mobile switching center 146 and provides a cellular base station controller conversion message signal 150b thereto, wherein the cellular base station controller conversion message signal 150b includes the cellular base station conversion message signal 150a and any modification created by the cellular base station controller 140, in accordance with known base station controller technology.

The mobile switching center 146 is further coupled to a plurality of other cellular base station controllers, not illustrated. In one embodiment of the present invention, through known information transfer and encoding techniques such as PCM encoding, a mobile switching center conversion message signal 150c is provided to a public switched telephone network (PSTN) 148 (shown generally as the interim network), wherein the mobile switching center conversion message signal 150c includes the cellular base station controller conversion message signal 150b and any modification created by the mobile switching center 146, in accordance with known mobile switching center technology, such as for example SS7, C7, or ISUP control signaling information. The PSTN conversion message signal 134 is then provided to a communication device 126 connectively coupled to the PSTN. In another embodiment, mobile switching center conversion message signal 150c may be passed to communication device 126 via the interim network 148 other than the PSTN, examples including, but not limited to, a packet data network, the Internet, an enterprise PBX network, a WLAN. Additionally, the connection between the MSC 146 and interim networks may include other network elements not shown such as gateways, multiplexers, firewalls, as known in the art of network communications for grooming, formatting or providing required control signaling to complete a communications path between communication device 124 and communication device 126.

In order to facilitate a seamless hand off between the wireless area network 100 and the cellular network 138, a switch in the providing of the incoming message signal to the second communication device 126, illustrates at 134, is made. In one embodiment, the switch may be made within the interim network 148 which provides operation via dedicated hardware, software or a combination thereof for switching the incoming signal 132 and 150c are synchronized. As recognized by one having ordinary skill in the art, the location of the actual switch between the cellular signal 150c and the wireless area network signal 132 may be provided at any suitable location as long as the second communication device 126 is provided a synchronized output.

The CDMA cellular timing recovery receiver 106 represents the combination of known CDMA cellular receiver elements disposed within a cellular mobile station with a digital phase locked loop (DPLL). FIG. 3 illustrates in block diagram form the operation of the CDMA cellular timing recovery receiver 106. The CDMA cellular timing recovery receiver 106 includes a front end receiver 151, a rake receiver 152, an inverse fast Hadamard transformer 154, a synchronization channel decoder 156 and a digital phase lock loop 158.

In one embodiment, the receiver front end 151 receives the forward link 118, which includes the synchronization channel and the pilot channel and thereupon generates a sampled and filtered intermediate frequency output signal 160. The intermediate frequency output signal 160 is thereupon provided to the rake receiver 152. The rake receiver correlates, de-spreads, and performs max-ratio diversity combining on each found CIR (Channel Impulse Response) and generates a demodulated baseband signal 162, which is provided to the inverse fast Hadarmard transform block 154. The inverse fast Hadamard transformer, in accordance with known transformation techniques, generates an encoded synchronization channel 164. The encoded synchronization channel 164 is provided to the synchronization channel decoder 156 which thereupon generates the clock setting signal 122 that is provided to the access point 104.

The rake receiver 152 also generates a clock signal 166 that is provided to the digital phase lock loop 158. In one embodiment, the clock signal 166 is a 1.2288 MHz signal with an 8 times oversampling, but as recognized by one having ordinary skill in the art, any other suitable frequency may be generated by the rake receiver 152 and utilized by the digital phase lock loop 158. In one embodiment, the digital phase lock loop may operate in accordance with U.S. Pat. No. 3,983,498 entitled DIGITAL PHASE LOCK LOOP. The digital phase lock loop 158 thereupon generates the clock pulse 120, which is thereupon provided to the access point 104.

FIG. 4 illustrates a graphical representation of a single frame of message information 170, for example, such as previously disclosed message information 130. The frame 170 includes a preamble 172, a synchronization field 174, a control field 176, an address field 178, a payload field 180a and a correction code field 182, in accordance with known technology relating to frames of message information. Moreover, the payload 180a includes a vocodor payload 180b which is designated to the particular network the frame is transmitted therethrough. For example, in a CDMA frame, the vocodor payload 180b may use an EVRC IS-127 encoded vocodor and a GSM frame may use a CELP type vocodor.

As such, the first communication device 124 is capable of providing the message information 130 having different vocodor payloads consistent with the particular network through which the message information is transmitted. For example, the communication device 124, prior to being within range of the WLAN 100 provides message information 130 having a vocodor payload consistent with the standards for the CDMA cellular network. When the communication device 124 is within range of the wireless area network 100, for example the radio signal strength indicator is equal to or above a threshold value, the communication device 124 provides the message information 130 having a vocodor payload consistent with the wireless area network standard, such as, but not limited to, Bluetooth or 802.11 b standards. Prior to the seamless hand off, the communication device may generate multiple frames for the same message information, wherein the multiple frames contain variant vocodor payloads 180b.

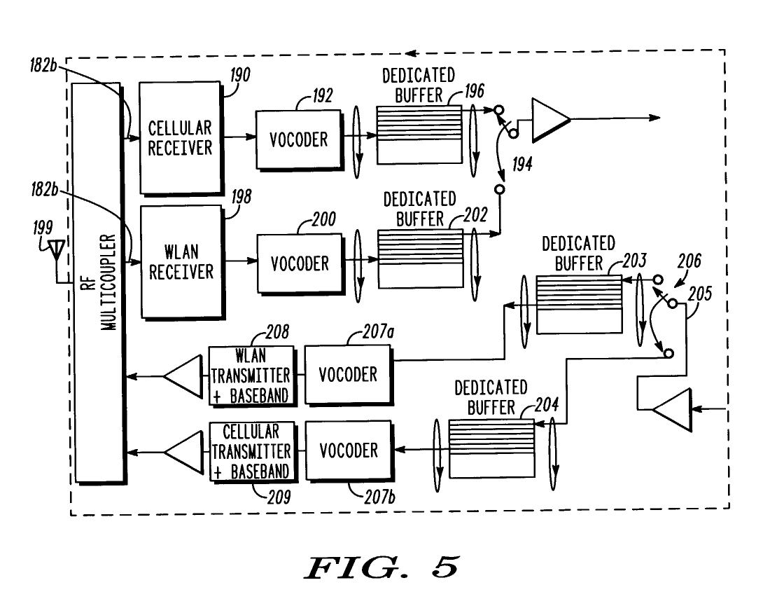

FIG. 5 illustrates a block diagram of the seamless hand off between the cellular network receiver 190, and the wireless receiver 198. As recognized by one having ordinary skill in the art, FIG. 5 is illustrative only, wherein many elements have been omitted for clarity purposes only. The cellular network receiver 190 receives the baseband information and vocodor payload, such as 180b, from the first communication device, via the antenna 191. After processing the baseband information and vocodor payload, a cellular message information signal 192 is provided to the second communication device 126 through a switch 194. Based on timing information and possible timing disparity, a dedicated buffer 196 is disposed between the receiver 190 and the switch 194 wherein frames of information may be stored.

When the first communication device is within close enough proximity to the wireless area network 100, the wireless receiver 198 receives the baseband information and the vocodor payload via an antenna 199. The wireless area network receiver 198 provides a network message signal 200 to a dedicated buffer 202, wherein the network message signal 200 is stored therein, in a frame-by-frame basis.

In a seamless hand off, when the network message signal is generated, the switch 194 switches to receive the network message signal 200 directly from the wireless receiver 194 after receiving a full frame from the cellular receiver 190. As such, from the perspective of the second communication device (not shown), a full frame is received from the cellular receiver 190 and then the next frame of message information is received from the wireless receiver 198 via the switch 194. As recognized by one having ordinary skill in the art, the dedicated buffers 196 and 202 provide for the seamless hand off in the event there exists disparity in the timing information wherein if frames must be stored in a particular buffer, such as 202, the second communication device (not shown) will read the frame from the particular buffer 202 while the wireless receiver 198 writes frames in a real time fashion to the buffer 202, such that a time disparity may exist, but the hand off between the different networks will be seamless to the second communication device 126.

In one embodiment, the switch 194 is disposed within the interim network 148 of FIG. 2, wherein the interim network 148 includes the functionality, disposed in hardware, software, or a combination thereof, to detect when a second frame of message information, such as 202, is ready to be provided to the second communication device. Moreover, the switch 194 includes determining the timing information of the second frame of message information wherein the switch 194 may switch income signal provided to the second communication device (not shown) in a seamless manner.

FIG. 5 further illustrates the reverse stream handover with a first dedicated buffer 203 and a second dedicated buffer 204 that receive a message signal 205 via switch 206. From the dedicated buffer, 203 or 204, a vocoder payload 207a or 207b depending on switch 206, is provided to a transmitter and baseband, wherein vocoder payload 207a is provided to a cellular transmitter and baseband 208 and vocoder payload 207b is provided to a WLAN transmitter and baseband 209. Whereupon, the message signal 205 is thereby provided to the RF multicoupler 108 from transmission to the first communication device (not shown).

FIG. 6 illustrates a flowchart of the steps of the first communication device 124 in providing for the seamless hand off between the cellular network 138 and the wireless area network 100. The method begins 210 by the first communication device 124 recognizing the availability of the wireless area network 100, step 212. As discussed above, in one embodiment, this is accomplished by the radio signal strength indicator being equal to or above a threshold value, wherein a threshold value may be determined by one having ordinary skill in the art based on the type of communication device and the type of wireless area network. The next step, 214, is setting up the wireless area network call which may include, among other things, initializing the communication device with the wireless area network and initializing internal routines within the communication device to allow for the generation of the message signal 130 for the wireless area network 100.

Next, step 216, the same baseband information is transmitted to the cellular network 138 and the wireless area network 100, wherein the baseband information, within the message information, includes variant vocodor payloads. Thereupon, the cellular and wireless area network baseband information is received by the interim network 148, step 218. As such, based on the CDMA cellular timing recovery receiver 106 within the wireless access point 102, the baseband information received by the interim network 148 includes synchronized frames of information provided across different networks, such that the switch 194 may adjust to the wireless area network pointer and provide the current frame of information to the second communication device 126, step 220. Wherein, prior to step 220, the second communication device received the frame of information transmitted across the cellular network. Thereupon, a seamless hand off between the cellular network 138 and the cellular network 100 is completed, step 222.

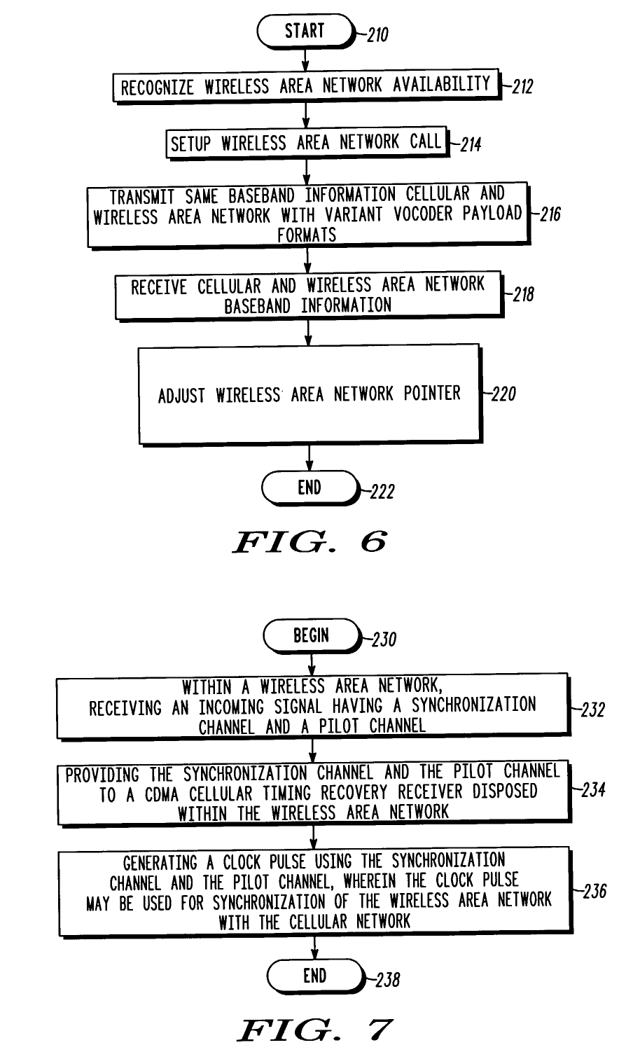

FIG. 7 illustrates the steps for a method for the synchronized hand off from the cellular network 138 to the wireless area network 100. The method begins, step 230, by receiving an incoming signal having the synchronization channel and the pilot channel 112 within the access point 102 of the wireless area network 100, designated at step 232. The next step, 234, is providing the synchronization channel and the pilot channel 112 to the CDMA cellular timing recovery receiver 106 disposed within the access point 102. Thereupon, the next step, 236, is generating the clock pulse 120 using the synchronization channel and the pilot channel 112, wherein the clock pulse 120 may be used for the synchronization of the cellular network with the wireless area network 100. Thereupon, step 238, the cellular network 138 has been synchronized and handed off to the wireless area network 100.

As previously described above, it is also noted that the synchronization channel and the pilot channel 112 are provided to the wireless area network 100 from the cellular base station 114. As also noted that the clock pulse 120 is further provided to the wireless area network circuit 104, such as, limited to, the Bluetooth circuitry, to produce the wireless network output signal 132. It is further noted, that the wireless area network 100 receives the message signal 130 from the first communication device 124, wherein the first communication device 124 also provides the message signal 130 to the cellular base station 114 such that the cellular base station 114 provides the cellular message signal 150d to the second communication device 126 across the cellular network 138. The above step further includes providing the message signal 130 to the wireless area network circuit 104 such that the wireless area network circuit generates the wireless area network message signal 132 and transmitting the wireless network message signal 132 to the second communication device 126 in synchronization with the cellular message signal 150d. Moreover, in one embodiment, the cellular timing recover receiver is the CDMA cellular timing recovery receiver 106.

Within the CDMA cellular timing recovery receiver 106, the step of providing the synchronization channel and pilot channel 118 to the CDMA cellular timing recovery receiver 106 includes receiving the forward link 118 which contains the synchronization channel and the pilot channel 112, generating an intermediate frequency output signal 160, generating a demodulated baseband signal using the intermediate frequency output signal 162, generating a clock pulse 164 using the intermediate frequency output signal 160, generating an encoded synchronization channel 164 using the demodulated baseband signal 162 and generating a clock setting signal 122 in response to the encoded synchronization channel 164. Thereupon, the clock pulse 120 is provided to the access point 104 and the clock setting signal 122 is provided to the access point 104 also.

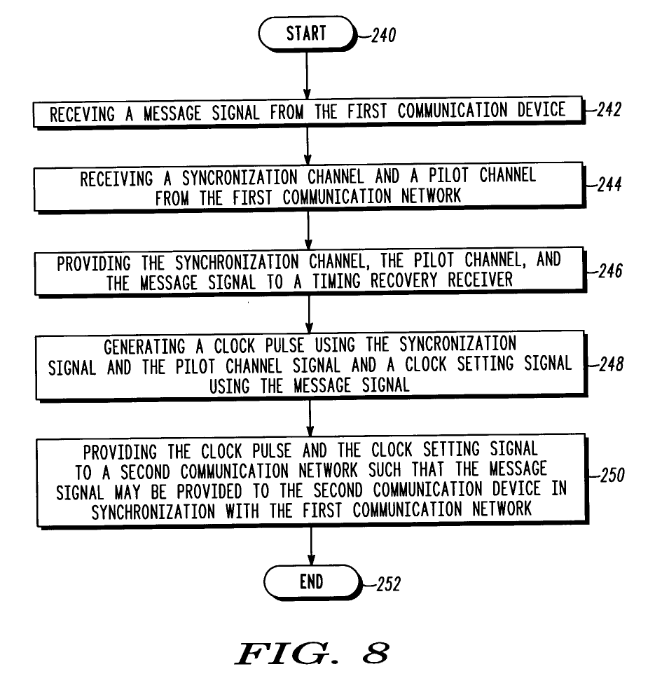

FIG. 8 illustrates a method for the synchronized hand off between a first communication network, such as the cellular network 138 and a second communication network, such as the wireless area network 100, such that the message signal 130 from the first communication device 124 is provided to the second communication device 126 across the first communication network. The method begins, 240, by receiving the message signal from the first communication device 124, step 242. The next step 244, is receiving the synchronization channel and pilot channel 112 from the first communication network. Thereupon, the synchronization channel and pilot channel 112 are provided to a timing recovery receiver, such as 106, designated at step 246.

The next step 248, is generating the clock pulse 120 using the synchronization channel and the pilot channel 112 and the clock setting signal 120 using the synchronization channel. Thereupon, the next step 250 is providing the clock pulse 120 and the clock setting signal 122 to a second access point, such as 104, such that the message signal 130 may be provided to the second communication device 126 in synchronization with the first communication network 138. Thereupon, step 252, the communication between the first communication device 124 and the second communication device 126 may be synchronously handed off between the first communication network and the second communication network.

In one embodiment, the message signal 130 and the synchronization channel and the pilot channel 112 are received by the second communication network antenna, such as 110, of the second communication network and the synchronization channel and the pilot channel 112 are provided to the timing recovery receiver from the second communication antenna. In another embodiment, prior to providing the synchronization channel and pilot channel 112 and the message signal 130 to the timing recovery receiver, the synchronization channel and pilot channel 112 and message signal 130 may be provided to a radial frequency coupling device. Moreover, in one embodiment, the synchronization channel and pilot channel 112 are provided to the wireless area network 100 from the cellular base station 114.

It should be understood that there exists implementations of other variations and modifications of the invention and its various aspects, as may be readily apparent to those of ordinary skill in the art, and that the invention is not limited by the specific embodiments described herein. For example, the present invention may further provide for the synchronized hand off between the first communication device 124 and the second communication device 126 where the hand off is in response to the first communication device going outside of the wireless area network range. Wherein, the original communication is across the wireless area network 100 and the hand off provides for the communication to thereupon be across the cellular network 138. It is therefore contemplated and covered by the present invention, any and all modifications, variations, or equivalence to fall within the spirit and scope of the basic underlying principals disclosed and claimed herein.

What is claimed is:

1. A wireless area network access point comprising:
an antenna, such that the antenna receives an incoming signal having a synchronization channel and a pilot channel; and
a code division multiple access cellular timing recovery receiver operably coupled to the antenna, wherein the code division multiple access cellular timing recovery receiver receives the synchronization channel and the pilot channel of the incoming signal from the antenna.

2. The wireless area network access point of claim 1 further comprising:
a radio frequency coupling device operably coupled to and disposed between the antenna and the code division multiple access cellular timing recovery receiver.

3. The wireless area network access point of claim 1 wherein the incoming signal is a radio frequency signal.

4. The wireless area network access point of claim 3 such that the antenna receives the incoming signal from a cellular base station.

5. The wireless area network access point of claim 1, wherein the code division multiple access cellular timing recovery receiver comprises:
a front end receiver that receives a forward link from the antenna;
a rake receiver coupled to the front end receiver, wherein the rake receiver receives an internal frequency output signal from the front end receiver;
an inverse fast Hadamard transformer operably coupled to the rake receiver, wherein the inverse fast Hadamard transformer receives a demodulated base band signal from the rake receiver;
a synchronization channel decoder operably coupled to the inverse fast Hadamard transformer such that the synchronization channel decoder receives an encoded synchronization channel from the inverse fast Hadamard transformer and produces therefrom a clock setting signal; and
a digital phase lock loop operably coupled to the rake receiver such that the digital phase lock loop receives the internal frequency output signal from the rake receiver and produces therefrom a clock pulse.

6. The wireless area network access point of claim 5 further comprising:
a wireless access network circuit operably coupled to the digital phase lock loop and receives the clock pulse therefrom and operably coupled to the synchronization channel decoder and receives the clock setting signal therefrom.

7. A method for a synchronized hand off from a cellular network to a wireless area network, the method comprising:
within an access point of the wireless area network, receiving an incoming signal having a synchronization channel and a pilot channel;
providing the synchronization channel and the pilot channel to a code division multiple access cellular timing recovery receiver disposed within the access point; and
generating a clock pulse using the synchronization channel and the pilot channel, wherein the clock pulse may be used for synchronization of the wireless network with the cellular network.

8. The method of claim 7, wherein the synchronization channel and the pilot channel are provided from a cellular base station.

9. The method of claim 8 further comprising:
providing the clock pulse to a wireless area network circuit to produce a wireless network output signal.

10. The method of claim 9 further comprising:
receiving a message signal from a first communication device, wherein the first communication device also provides the message signal to the cellular base station such that that the cellular base station provides a cellular message signal to a second communication device across the cellular network.

11. The method of claim 10 further comprising:
providing the message signal to the wireless area network circuit such that the wireless area network circuit generates a wireless network message signal;
transmitting the wireless network message signal to the second communication device in synchronization with the cellular message signal.

12. The method of claim 7 wherein the cellular timing recovery receiver is a code division multiple access cellular timing recovery receiver.

13. The method of claim 12 wherein the step of providing the synchronization channel and the pilot channel to the code division multiple access cellular timing recovery receiver disposed within the access point further comprises:
receiving a forward link containing the synchronization channel and the pilot channel;
generating an intermediate frequency output signal;
generating a demodulated baseband signal using the intermediate frequency output signal;
generating a clock pulse using the intermediate frequency output signal;
decoding the synchronization channel using the demodulated baseband signal; and
generating a clock setting signal in response to the decoded synchronization channel.

14. The method of claim 13 further comprising:
providing the clock pulse to a wireless area network circuit; and
providing the clock setting signal to the wireless area network circuit.

15. A method for a synchronized hand off between a first communication network and a second communication network such that a message signal from a first communication device is provided to a second communication device across the first communication network, the method comprising:
receiving the message signal from the first communication device;
receiving a synchronization channel and a pilot channel from the first communication network;
providing the synchronization channel and the pilot channel to a timing recovery receiver;
generating a clock pulse using the synchronization channel and the pilot channel and a clock setting signal using the synchronization channel; and
providing the clock and the clock setting signal to a second communication network circuit such that the message signal may be provided to the second communication device in synchronization with the first communication network.

16. The method of claim 15 wherein the synchronization channel and the pilot channel are received by a second communication network antenna of the second communication network and the synchronization channel and the pilot channel are provided to the timing recovery receiver from the second communication antenna.

17. The method of claim 16 wherein prior to providing the synchronization channel and the pilot channel to the timing recovery receiver, the synchronization channel, the pilot channel and the message signal are provided to a radio frequency coupling device.

18. The method of claim 15 wherein the first communication network is a cellular network and the second communication network is a wireless area network.

19. The method of claim 18 wherein the synchronization channel and the pilot channel are provided to the wireless area network from a cellular base station.
